(19) United States
(12) Patent Application Publication
(10) Pub. No.: US 2026/0267890 A1
(43) Pub. Date: Sep. 10, 2026

(54) ADAPTIVE CHUNKING WITH SIMILARITY METRIC (ACSM)

(71) Applicant: HEWLETT PACKARD ENTERPRISE DEVELOPMENT LP, Spring, TX (US)

(72) Inventors: SIDHANT ARORA, Spring, TX (US); UMANG KEDIA, Spring, TX (US); PON ARASU NERANJ SUBRAMANIAN, Spring, TX (US); IAN MATTHEWS, Galway (IE); MARK PERREIRA, Sunnyvale, CA (US)

(21) Appl. No.: 19/072,320

(22) Filed: Mar. 6, 2025

(51) Int. Cl. G06F 16/334; G06F 16/93

(52) U.S. Cl. CPC G06F 16/3347; G06F 16/93

(57) ABSTRACT

Systems and methods are provided for implementing an adaptive chunking process with a similarity metric for improved Retrieval-Augmented Generation (RAG). The process may hierarchically and iteratively determine a set of characters in the document that delineate chunks of data and convert the chunks into a vector embeddings. The hierarchical and iterative determination can be based on a chunking procedure that prioritize paragraphs first, sentences, second, and words third relative to specified or calculated boundary limits.

### BACKGROUND

Traditional machine learning (ML) models and artificial intelligence algorithms have made great strides in a variety of prediction tasks. For example, a large language model (LLM) uses deep learning techniques and massively large data sets to understand, summarize, generate, and predict new content. Traditional LLMs use transformer models and a large number of parameters to understand and generate accurate responses rapidly, which makes the AI technology broadly applicable across many different domains.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a block diagram of an example environment with a retrieval augmented generation (RAG) system for adaptive chunking with a similarity metric, in accordance with examples of the disclosed technology.

FIG. 2 illustrates an adaptive chunking process, in accordance with examples of the disclosed technology.

FIG. 3 illustrates operations that can be performed to effectuate adaptive chunking in accordance with examples of the disclosed technology.

FIGS. 4A and 4B illustrate paragraphs of an example document to be adaptively chunked in accordance with examples of the disclosed technology.

FIG. 4C illustrates an example of adaptive chunking as applied to the example document of FIGS. 4A and 4B.

FIG. 4D illustrates another example of adaptive chunking as applied to the example document of FIGS. 4A and 4B.

FIG. 5 is an example computing component that may be used to implement adaptive chunking and chunk merging in accordance with examples of the disclosed technology.

FIG. 6 is a computing component that may be used to implement examples of the disclosed technology.

The figures are not exhaustive and do not limit the present disclosure to the precise form disclosed.

### DETAILED DESCRIPTION

Retrieval-Augmented Generation (RAG) is an artificial intelligence (AI) framework for retrieving facts from an external knowledge base (context) to enhance the output of LLMs with information that results in a more contextually relevant or accurate response. Examples of the disclosed technology improve upon conventional or traditional RAG systems by implementing adaptive chunking, which can refer to a method of hierarchical and iterative processing of a document or other information source to achieve optimally chunked data for use by the RAG system, an LLM, etc. Moreover, in some examples, improvements may be realized by merging certain chunks (generated via adaptive chunking) based on the chunks' similarity to each other. Thus, the adaptive chunking can optimize how a document/information source is broken up for easier and faster analysis (similarity comparisons) and retrieval, while any subsequent merging of two or more similar chunks preserves or further enhances context retention between chunks. It should be noted that such adaptive chunking, and the use of RAG is performed/occurs in real-time, e.g., when responding to queries in the context of generating LLM outputs.

In RAG, the aforementioned external knowledge base can be accessed, and information stored in the external knowledge can be retrieved. The information can be analyzed and used to generate a response to a query, prompt, or other input (used interchangeably) from a user. Such information is typically in the form of documents, but can also be gleaned from other sources of information. That is, and for example, a RAG software agent or component can identify certain documents that are relevant to the user query/prompt/input, which can then be provided to an LLM. The LLM, in turn, can generate a response to the query/prompt/input that is based on the documents.

In some examples, a RAG system or framework can be thought of as comprising multiple sub-processes, including a first “pre-processing” sub-process, a second “retrieval” sub-process, and a third “post-processing” sub-process.

The first sub-process involves preparing the documents as data, e.g., extracting data from the documents. Typically, a document, which can include paragraphs, sentences, words, and punctuation are separated into smaller subsets of the document, referred to as chunks, and the RAG system may encode each of the chunks into a vector embedding or other numerical representation of those chunks that make up the document.

A RAG system can initiate retrieval of pre-processed data pursuant to receiving a query from a user. It should be understood that chunks are typically transformed into vector embeddings, and a RAG system can access these vector embeddings (or chunks) to generate a response to the query. Vector embeddings are numerical representations of data (in this case, numerical representations of chunks of unstructured data). The vector embeddings (by virtue of being numerical representations)reduce data dimensionality, and yet allows important features of the data to be captured. The points (of a vector) identified in space may be semantically meaningful to machine learning (ML) models. For example, once the query is received, a RAG system can vectorize the query, and look for matches within the vector embeddings stored in the external knowledge base (the chunks). By looking for such matches, the RAG system is able to identify and select relevant pieces of information from the external knowledge base, where the relevance of the information corresponds to its similarity to the query. Using the retrieved data, a machine learning model (e.g., RAG, LLM, or other transformer-based architectures) can process the retrieved information along with the original query to create a group of potential responses to the query.

The third sub-process of the RAG (post-processing) can filter and rank the potential responses that are retrieved. The filter/rank can help determine whether the generated responses meet specific phrasing or similarity criteria. For example, the filtering and ranking can remove responses based on relevance or fluency with respect to the initial search query/prompt. The system may also modify the generated text to improve clarity and coherence of the response by rephrasing sentences or adjusting tone and style.

Responses can be ranked and the best response can be provided back to the user.

Technical improvements are described throughout the disclosure. For example, traditional systems can generate chunks of data at a fixed size during a first sub-process of the RAG (pre-processing). Traditional systems may attempt to improve inadequacies of the first sub-process by implementing the third sub-process (post-processing). While the third sub-process can enhance data quality, coherence, and relevance, the first sub-process in traditional systems may remain inadequate. Examples of the improved system disclosed herein can supplement or avoid the third sub-process (post-processing) altogether or otherwise reduce its importance in the ultimate output processing by improving the first sub-process, thus creating a more efficient RAG system overall. In traditional systems, performance of this third sub-process could cause unnecessary processing time/use of resources with respect to user query matches and obtaining the “best” chunk (performed during the second sub-process (retrieval)). For example, the first sub-process of the RAG can increase/adapt the chunk size and incorporate a similarity metric to produce larger, similar chunks that are used in the data retrieval process. The larger-sized chunks may be well-suited for a wide range of text processing tasks, including document summarization, information extraction (via an LLM), and text classification.

Additionally, the larger-sized chunks may be adaptive in size to help cover the logical boundary and complete description included in the paragraph, so that the RAG can retrieve a complete logical concept in generating a coherent response to the query. This is distinguishable from traditional systems that can split a single concept into multiple, disjointed chunks that are not retrievable together by the RAG and generate an often incoherent or incomplete response to the query.

In some examples, the adaptive chunking process can dynamically adjust the chunk size within a defined range, allowing for flexibility while maintaining coherence. Contextually similar chunks may be identified, and merged together to form a single, larger-sized chunk, which can allow later retrieval of the larger-sized chunk to include the most relevant data in the response.

In some examples, a similarity metric is implemented with the adaptive chunking. For example, the similarity metric may programmatically identify similarities between initial chunks. This may help ensure semantic coherence and smooth transitions between adjacent chunks, which can improve the retrieval process for generating relevant data for the response.

In some examples, enhanced readability is implemented when the system can identify relevant, related, larger-sized chunks to use in generating a response to a user prompt/query. For example, by considering both chunk size and similarity with neighboring chunks, examples of the disclosed technology can generate high-quality chunks of data that are both informative and coherent from a RAG perspective/LLM response perspective.

In some examples, retrieval of the larger-sized chunks can improve the overall process described herein. For example, by precomputing and merging the initial chunks based on similarity metrics, the system can efficiently organize and index the documents that are searched in generating a response to a user prompt/query. This can enable the system to swiftly identify and present relevant data, in the form of larger-sized chunks, to the user queries.

In some examples, the semantic coherence of chunks is determined when the larger-sized chunks are generated. By relying on the semantic coherence of the chunks, the retrieval process can be more precise and comprehensive, as chunks inherently contain semantically related information. Consequently, the system can retrieve the chunks with improved accuracy and efficiency, as the precomputed larger-sized chunks streamline the retrieval process by aligning closely with the user prompt/query, and ultimately resulting in a more satisfying user experience because the response better aligns with the original query/prompt.

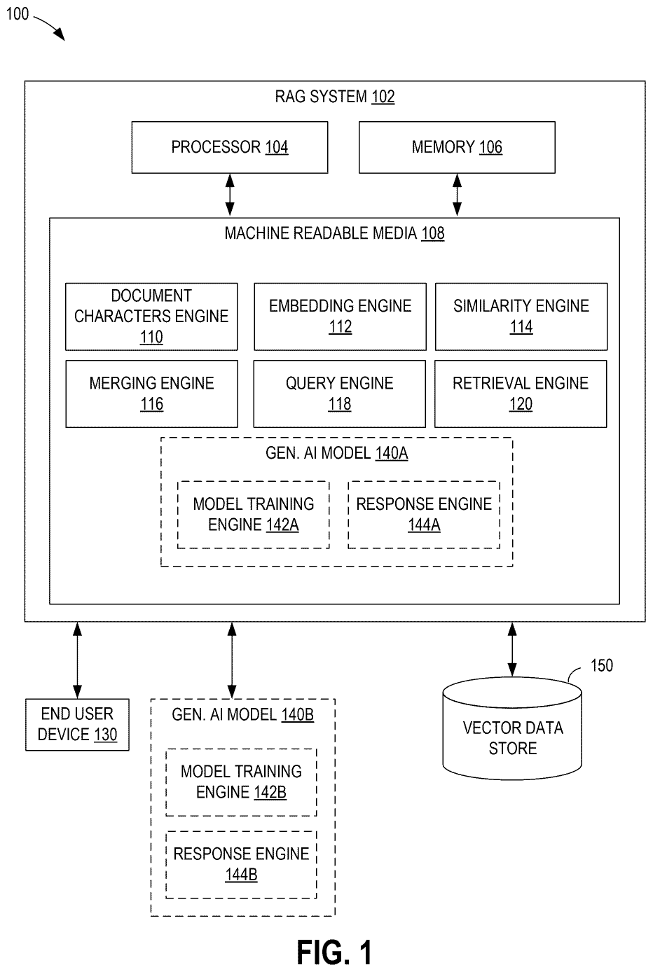

FIG. 1 is a block diagram of an example environment for RAG, in accordance with implementations of the present disclosure. In example 100, the environment comprises RAG system 102 that is communicable with (e.g., via wired or wireless communication connection) end user device 130, generative AI model 140, and vector data store 150.

RAG system 102 may be a server computer, a controller, or any other similar computing component capable of processing and transmitting data via network communications to the other devices. In the example of FIG. 1, RAG system 102 comprises processor 104, memory 106, and machine readable media 108.

Processor 104 may be one or more central processing units (CPUs), semiconductor-based microprocessors, and/or other hardware devices suitable for retrieval and execution of instructions stored in machine-readable storage medium 108. Processor 104 may fetch, decode, and execute instructions to control processes or operations for implementing adaptive chunking. As an alternative or in addition to retrieving and executing instructions, processor 104 may include one or more electronic circuits that include electronic components for performing the functionality of one or more instructions, such as a field programmable gate array (FPGA), application specific integrated circuit (ASIC), or other electronic circuits.

Memory 106 may comprise random-access memory (RAM) or other dynamic memory for storing information and instructions to be executed by processor 104. Memory 106 might also be used for storing temporary variables or other intermediate information during execution of instructions to be executed by processor 104. Memory 106 may also comprise a read only memory (“ROM”) or other static storage device coupled to a bus for storing static information and instructions for processor 104.

Machine readable media 108 may comprise one or more interfaces, circuits, and modules for implementing the functionality discussed herein. Machine readable media 108 may carry one or more sequences of one or more instructions that can be executed by processor 104. Thus, machine-readable storage medium 108 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 108 may be a non-transitory storage medium, where the term “non-transitory” does not encompass transitory propagating signals. Such instructions embodied on machine readable media 108 may enable RAG system 102 to perform features or functions of the disclosed technology as discussed herein. For example, the interfaces, circuits, and modules of machine readable media 108 may comprise, for example, document characters engine 110, embedding engine 112, similarity engine 114, merging engine 116, query engine 118, and retrieval engine 120.

Typically, a document may comprise one or more paragraphs. A paragraph may comprise one or more sentences. A sentence may comprise one or more words. In accordance with examples of the disclosed technology, the basis of chunking can vary, whereby a document may be initially chunked on the basis of paragraphs relative to defined boundaries. As will be described in greater detail below, examples of the disclosed technology may receive user-specified boundary limits, e.g., upper word boundary and lower word boundary (or may alternatively determine optimal upper and lower word boundaries). That is, chunking can be performed based on whether a paragraph at least one of meets a lower word boundary, or meets an upper word boundary. In some examples, a word range may also be specified. In some scenarios, one or more paragraphs of a document may not be optimally chunked due to not meeting a lower word boundary, or exceeding an upper word boundary, in which case, examples of the disclosed technology “adapt” the chunking to then move to sentence-based chunking to determine if the resulting chunks would then comport with the lower/upper word boundaries. If sentence-based chunking still does not result in the optimally-sized chunks, chunking can again be adapted, this time, on a word-by-word basis. It should be noted that despite the basis of chunking changing, any resulting chunk still comports with the specified or calculated word boundaries. It should be noted that in some examples, the lowest level of chunking is the word level to help ensure that chunks are meaningful. This is opposed to, e.g., character-based chunking that would likely result in fragments of test that lack coherence/context.

More particularly, initial chunks may comprise multiple sentences within word boundary limits (e.g., determined from a profile or user input). For example, when the initial chunks are separated by a newline character, each initial chunk may correspond to a paragraph. Consider, for example, that a user has specified a 100-word “window” as a preferred size for a chunk, where, based on the aforementioned adaptive chunking, the preferred size of a chunk can be adjusted within a word range of between 80 words (lower boundary) and 118 words (upper boundary). As used herein, the term “window” may identify a subset of words in a document that can be configured to move systematically through the document to highlight a subset of words at a time. The size of the window may be configured (e.g., in a profile or through user input, or as will be discussed below,) . As the window moves throughout the document, the system can detect the characters in the window and determine whether the identified character is present (e.g., space, period, newline, etc.).

A word limit can correspond to a restriction on the number of words in the larger-sized chunk or a range of words. When a range is implemented, the detected characters may include a threshold value (e.g., 100 words) and a threshold range (e.g., a lower limit of 80 words and an upper limit of 118 words may be accepted). In some examples, the window size and word limit can be defined by user/profile or calculated, and allow for flexibility in chunk size while maintaining coherence throughout the document.

The initial chunks may be merged when a similarity metric of the chunks are within a similarity threshold of each other. The “similarity metric” can be a similarity calculation that defines the similarity between two chunks (in each chunk's vector embedding form) when the initial chunks are compared with each other. The similarity calculation may be computed using a cosine similarity or other similarity analysis. The similarity metric may be within a range from 0 to 1, where 1 is indicative that the vector embeddings are the same, and where 0 means the vector embeddings are orthogonal (completely dissimilar). When the similarity metric exceeds a similarity threshold value, the initial chunks may be merged to programmatically generate larger-sized chunks comprising related concepts. This may help ensure semantic coherence and smooth transitions between adjacent chunks, which can improve the retrieval process for generating relevant data for the response (the second sub-process of the RAG).

Thus, RAG system 102 can be configured to implement a RAG process that comprises one or more sub-processes, including a first sub-process and a second sub-process. The first sub-process may comprise processing a document by determining a set of characters in the document as a chunk (by document characters engine 110), converting the chunk into a vector embedding (by embedding engine 112), determining a first similarity value between the vector embedding and other vector embeddings in the document (by similarity engine 114), and merging the chunk and other chunks corresponding with the other vector embeddings (by merging engine 116). The second sub-process may comprise receiving a query/prompt with a RAG process (by query engine 118), retrieving relevant chunks/embeddings to the query/prompt (by retrieval engine 120), and generating a response to the query/prompt, using the trained ML model associated with the RAG process (trained by model training engine 142) and providing the response to an interface (by response engine 144).

RAG system 102 may be configured to process documents stored as electronic files to identify words or phrases via chunking. The document may be received via a network and stored as a data object in a data store. In some examples, RAG system 102 may access a corpus of documents stored in one or more data stores. The corpus of documents may correspond to a diverse knowledge base that can include textual documents (e.g. PDFs, documents generated by word processor programs, etc.), webpages, charts, graphs, images, videos, audio, multimedia content and the like.

Document characters engine 110 is configured to iteratively determine a character or subsets of characters in the document (e.g., words, phrases, etc.) and associate the characters with one another as a chunk of data for purposes of delineating or identifying words, sentences, or paragraphs. Such chunks of data can be accessed/analyzed to determine if their vector embedding representations are similar to that of a query, in which case, such chunks of data can be retrieved and used to generate a response to that query.

The specific character may be defined in a user profile or as a default value associated with a chunking process. For example, when the determined character corresponding with a chunk is a period, the chunks of data may correspond with sentences in the document, since the end of a sentence includes the determined character (e.g., a period). In another example, when the character is a space, the chunks of data may correspond with words in a document, since the beginning and end of a word includes the determined character (e.g., a space).

In some examples, the character is a newline character. Newline characters may correspond with a programmatic rule in the document that causes characters after the newline to be placed on the next/following line. When the character is a newline character, the set of characters may identify a start of a paragraph and an end of the paragraph in the document, since the newline character exists in a document at the start and end of every paragraph to illustrate the bounds of the paragraph. A chunk may be identified within the start of the paragraph and the end of the paragraph in the document in association with the newline character.

In some examples, document characters engine 110 identifies the characters and chunks by defining window parameters. The window may identify a subset of characters in the document and detect whether the identified character is present in the window (e.g., space, period, newline, etc.), where characters can be used to delineate or determine the existence of words, sentences, or paragraphs.

As alluded to above, a word limit may correspond with a restriction on the number of words that can be grouped together in a chunk (e.g., as identified by spaces between a subset of characters). The word limit can correspond with a restriction on the number of words in the chunk or a range of words. When a range is implemented, the detected characters may include a threshold value (e.g., 100 words) and a threshold range (e.g., when 20 words is acceptable, a lower limit of 80 words and an upper limit of 118 words may be accepted). In some examples, the window size and word limits can be defined by user/profile and allow for flexibility in chunk size while maintaining coherence throughout the document.

Document characters engine 110 is also configured to segment or chunk the characters into tokens using a tokenization technique. The tokenization technique can convert a sequence of characters from the document into individual tokens of data. A particular character can be identified to delineate the tokens, such that when the character is identified (e.g., space, period, newline, etc.), a first token may end and a second token may begin. The tokens can be words, characters, sentences, or paragraphs depending on the level of tokenization, and identify portions of the document that can help identify the structure and content overall.

The tokenization technique may include adaptive chunking. As described above, and in accordance with examples of the disclosed technology, creating such chunks of data can be performed using an adaptive chunking policy or mechanism. Again, adaptive chunking can involve hierarchical and iterative chunking processes that first attempt to create chunks on a paragraph-by-paragraph basis, where the chunks comport with a particular boundary specification/boundary limits, e.g., lower boundary and upper boundary, or with a word window that can adaptively grow/shrink depending on the basis according to which chunking is performed. If paragraph-by-paragraph chunking runs afoul of the boundary limits/word window, chunking can be performed on a sentence-by-sentence basis to see if breaking up a document or portion of a document by sentences. If the boundary limits/word window still cannot be met, word-by-word chunking can be performed. It should be understood that, e.g., some paragraphs of a document may be able to be chunked on a per-paragraph basis, but some may not. The shift to, e.g., sentence-by-sentence chunking need not occur for all paragraphs, but can be applied in a limited manner to just those paragraph-based chunks that are problematic (do not comport with defined boundary limits/word window).

For example, the process may move a sliding window of 100 words through the text. The window size may be dynamically adjusted within a defined range (e.g., 80-118 words) based on the content of the text. When the window reaches the end of the text, the process may ensure that the last chunk extends to cover any remaining words. In other words, the content of the text may be paragraphs, sentences, and words, and depending how chunks are sized/would be sized by applying paragraph, sentence, or word-based chunking, one of these bases for chunking can be applied in a hierarchical manner as described above. In some examples, a sliding (word) window need not necessarily be specified. A word-based size range, e.g., upper and lower boundaries, on its own, can be used to the same effect, i.e., providing the ability to adapt chunk size within a desired range of number of words.

Embedding engine 112 is configured to generate an embedding of the chunk. In some examples, the embedding is generated using an imported library of rules that identifies the semantic relationships between words (e.g., Word2Vec, GloVe). The embedding may be a programmatic conversion of the data/chunk into a numerical array that expresses the data's original meaning.

Embedding engine 112 is also configured to store the embeddings in vector data store 150 or other data storage format. Vector data store 150 can refer to a database or repository that facilitates the storage and searching of unstructured data by embedding the unstructured data (converting unstructured data into a numerical array that expresses the data's original meaning) and storing the resulting embedding vectors (unique fingerprints/values for a piece of data). Vector data store 150 may be a cloud-based database, included as part of RAG system 102. Vector data store 150 may store embeddings that encode relevant data and corresponding chunks as embedding vectors. The model (e.g., a RAG model) may be trained to identify and fetch the most relevant documents/chunks associated with generating a response to the query/prompt.

In some examples, embeddings of the initial chunks that are generated by embedding engine 112 are stored in a temporary cache location or computer memory, and the embeddings of the merged chunks are stored in vector data store 150. The distinction in locations of the stored embeddings may help differentiate the data that are backed up (e.g., the merged chunks) and the data that are deleted in the temporary storage location (e.g., the initial chunks).

Similarity engine 114 is configured to identify similar or matching vector embeddings. Similarity can be determined based on a similarity metric of the vector embeddings being within a threshold similarity of each other. For example, the embedding associated with a first chunk and the embedding associated with a second chunk may be compared to determine whether or not they are contextually similar. similarity between the two embeddings. A similarity search can be conducted by similarity engine 114, which can access the embedding vectors that are stored in vector data store 150 and compare them to generate a similarity metric. The embeddings may be merged if the similarity metric for the embeddings are within a threshold similarity value (determined by merging engine 116).

In some examples, initial chunks are stored in a temporary cache location or computer memory, and the similarity search conducted by similarity engine 114 is limited to storing values in the temporary cache location or the computer memory as well. In response to finding similar initial chunks by similarity engine 114, the larger-sized chunks that are similar and merged may be stored in vector data store 150. In this way, the merged chunks may be the only data/embeddings that are stored in vector data store 150 (e.g., which is backed up or shared throughout a distributed computer system).

Various similarity searches may be implemented in determining the similarity metric. For example, similarity engine 114 is configured to implement a cosine similarity that defines the similarity between two embedding vectors between similarity metric ranges from 0 to 1, where 1 means identical vectors and 0 means orthogonal (completely dissimilar). In some examples, the cosine similarity is implemented by incorporating a library that determines the similarity metric (e.g., scikit-learn or spaCy). The similarity search can be executed to retrieve embeddings and other data used to generate a response to the query/prompt (by response engine 144).

Merging engine 116 is configured to merge similar chunks, based on the determined similarity metric between the embeddings for the chunks. For example, similarity engine 114 may calculate a similarity metric between each chunk (e.g., paragraph) and its neighboring chunks (e.g., other paragraphs) using the similarity search of the corresponding embeddings. Merging engine 116 may merge the chunks with a semantic coherence (e.g., exceeding a threshold similarity value) based on a first similarity analysis between other chunks in the same document. Merging engine 116 can iteratively merge the set of chunks until a pre-defined word limit is reached.

The calculated similarity metric may help determine whether to merge chunks. If the similarity between a chunk and its neighboring chunks exceeds the threshold similarity value, merging engine 116 may merge them into a single chunk, while limiting the maximum number of chunks that can be merged (e.g., based on a defined threshold value).

It should be noted that in traditional approaches, the chunking of a document is performed in a “static” manner. For example, chunking may be performed pursuant to some set, desired chunk size, e.g., 10 words, 20 words, and so on. Some traditional chunking methods may expand on this size-limited approach by allowing for some overlap, e.g., including the next 10 words of a following sentence, to hopefully retain the context of a chunk of data. However, while the use of fixed chunk sizes may be more efficient for a RAG system to implement, the resulting chunks may lose the context of the document or section of the document from which the chunks are generated. For example, chunks that are too small may miss/fail to include parts of a document that provide such context. The loss of this context may negatively affect later sub-processes, including the second sub-process (retrieval), because the chunks may be unable to be retrieved based on similarities and other calculations. If chunks are too large, the advantages of chunking (to avoid searching entire documents to ascertain relevance or find relevant portions thereof) can be lost.

Other formats for chunking data may be implemented as well, including document-specific chunking. In document-specific chunking, the structure of the document may be considered to create chunks that align with the logical sections of the document, like sub-sections of the document (e.g., an “Abstract” section or table definition). Semantic chunking is also available, which involves generating a chunk from every sentence in the document, comparing the similarity of all sentences with each other, and then grouping chunks that are most similar. Nevertheless, regardless of what approach to chunking is taken, traditional chunking that is premised on fixed sizes or that attempts to align with logical sections of a document is limiting in that it fails to achieve an optimal balance between more efficient searching (e.g., typically via smaller chunks) and maintaining context (e.g., typically via larger chunks). For example, although semantic chunking attempts to maintain semantic context, because sentence size can vary wildly, resulting chunks can correspondingly vary wildly.

In the context of conventional, sentence-based chunking or semantic-based chunking, the size of a chunk depends solely on sentence delimiters. Thus, as discussed above, chunks created in accordance with these conventional methods can vary significantly in size. However, as described herein, examples of the disclosed technology implement hierarchical and iterative chunking using a specified boundary limit. Thus, and although chunk size may still vary, it will be within this specified boundary. This prevents creating chunks that might be only 10 words long, while another chunk is 30 words long, which may not contain complete information as the chunk is too small to be meaningful. Even with a semantic chunking approach based on sentence-based chunks, the information might not be captured effectively, as it can cause only two sentences of just 10 words to get merged, missing other information that also needs to be included in a single chunk. Accordingly, examples of the disclosed technology are still able to realize advantages over conventional methods.

As described, examples of the disclosed technology may also merge chunks, which can also result in chunks of different sizes. However, despite engaging in chunk merging, advantages are still realized. That is, the initial, boundary limit-based hierarchical and iterative chunking performed in accordance with examples of the disclosed technology optimizes chunks for context retention and coherence at the outset. Thus, when these initial chunks are later-merged based on semantic similarity, the resulting chunks are meaningful and contextually coherent, outweighing disadvantages associated with disparately-sized chunks, when those chunks are created according to conventional methods. In other words, examples of the disclosed technology are able to balance chunk coherency with the practical constraints of chunk size. This is especially true in the context of modern LLMs that have significantly larger context limits than in the past, making it more beneficial to have meaningful chunks that capture the essence of a query.

Query engine 118 is configured to receive a query/prompt from the user, including via end user device 130. In some examples, query engine 118 implements an interface to receive the query and submit it generative AI model 140 (e.g., LLM or corresponding agent). Generative AI model 140 may be trained to initiate various processes, including finding relevant documents with information that the model uses to generate a response. Query engine 118 can determine chunks and corresponding embeddings that are within a latent space proximity to a semantically similar value of the query/prompt. In some examples, the embedding associated with the chunk and the embedding associated with the query/prompt may be compared in determination of the semantically similar value. The embeddings of the chunk may be retrieved if the embedding is relevant to an answer for the query/prompt (determined by response engine 144).

Retrieval engine 120 is configured to map the query/prompt to chunks/embeddings that were generated from the documents. For example, the chunks/embeddings may be combined into the larger-size embeddings and compared with the embedding of the query/prompt. The similarity between the chunk/embedding and the query may be determined using a similarity process (e.g., cosine similarity) as discussed when determining the similarity between the initial chunks of data (by similarity engine 114).

Retrieval engine 120 is also configured to execute a retrieval process. For example, upon receiving a query from end user device 130, retrieval engine 120 may locate and access embeddings in data store 150. Retrieval engine 120 may map the query/prompt to embedding/chunks in data store 150 based on similarity between the query and the embedding/chunks. An information retrieval algorithm (e.g., a RAG process) may be implemented to search the data store to retrieve data that are probabilistically relevant to the query.

In some examples, retrieval engine 120 may be configured to execute an information retrieval algorithm that compares numerical representations of each the query/prompt and the chunk/embedding stored in data store 150, and retrieve the data that are probabilistically similar to the embedding representation of the query. In examples, retrieval engine 120 may execute cosine similarity to compute a similarity score between the numerical representation of the query and numerical representations of the chunk/embedding. However, other methods for computing similarity may be used. The numerical representations of the chunks/embeddings can be sorted according to similarity score (e.g., highest similarity to lowest) and the most similar may be identified as probabilistically relevant to the query.

In some examples, the embedding of the larger-sized chunk is converted back into a text/image document that can be processed by generative AI model 140. The query can be feed to generative AI model 140 via prompt engineering. As explained above, generative AI model 140 applies its learned knowledge to the query and generates an output that is responsive to the query and according to the context defined by topic mapped to the query.

End user device 130 may be any computing device or system, such as, but not limited to, a smartphone, a laptop computer, a personal computer, a tablet, a wearable smart device, etc. End user device 130 may include an input device that may be employed for inputting a query into end user device 130. The input device may include, but is not limited to, alphanumeric and other keys, a mouse, a trackball, or cursor direction keys for communicating direction information and command selections, touches and on a touch screen, voice command inputs, and the like. In examples, an end user may input a query into end user device 130 via the input device with the end goal receive an output from generative AI model 140 that is relevant to the query.

Generative AI model 140 may be hosted internally (with RAG system 102) or by a third party system, illustrated as internal generative AI model 140A or external generative AI model 140B. In some examples, generative AI model 140 may be trained on trained on vast volumes of data from a general knowledge base and configured to generate outputs for tasks, such as answering queries, translating languages, and completing sentences. In examples, generative AI model 140 may be one or more LLM tools, such as but not limited to, the GPT series of models, Gemini, LLAMA models, and the like.

Generative AI model 140 comprises a processor, a memory, and a machine readable media. Instructions may be stored in machine readable media that can be executed by the processor to perform features or functions of the disclosed technology as discussed herein. For example, the machine readable media may comprise, for example, model training engine 142 (illustrated as internal model training engine 142A and external model training engine 142B) and response engine 144 (illustrated as internal response engine 144A and external response engine 144B).

Model training engine 142 is configured to implement a training phase on a machine learning model to teach the model to search for relevant data associated with a query/prompt and generate coherent and contextually appropriate responses. In some examples, supervised learning is used to train the generative part of the model (like a transformer-based language model) on a large corpus of text. The retrieval component of the model may be fine-tuned using supervised signals (e.g., using reinforcement learning), where the model learns to retrieve the most relevant documents or pieces of information from a large knowledge base. When reinforcement learning is implemented, model training engine 142 adjusts parameters of the model that changes how the model selects and ranks retrieved documents or how it generates the final output. This may cause the model to generate more accurate or contextually relevant responses.

Response engine 144 is configured to retrieve a larger-sized chunk or set of larger-sized chunks that are determined to be similar to the query/prompt and generate a response. The retrieved chunks may not be the initial chunks, but the larger-sized chunks that are determined to be similar to other chunks during the first sub-process “pre-processing” phase that merges chunks based on a similarity metric. Response engine 144 may retrieve relevant data for generating a response based on the similarity score between the embedding of the user prompt and the embeddings that are previously stored in vector data store 150. During the retrieval, response engine 144 may retrieve/fetch data from vector data store 150 with a similarity score that exceeds the threshold similarity value.

Retrieval may be improved (e.g., the second sub-process of the RAG) based on the chunking and merging described throughout the disclosure. For example, response engine 144 can access the vector embeddings associated with the merged chunks that combine relevant data before the query/prompt is received. Since the embeddings represent the data in its numeric form, the retrieval process is expedited to provide semantically meaningful information to machine learning (ML) models (e.g., RAG, LLM, or other transformer-based architectures).

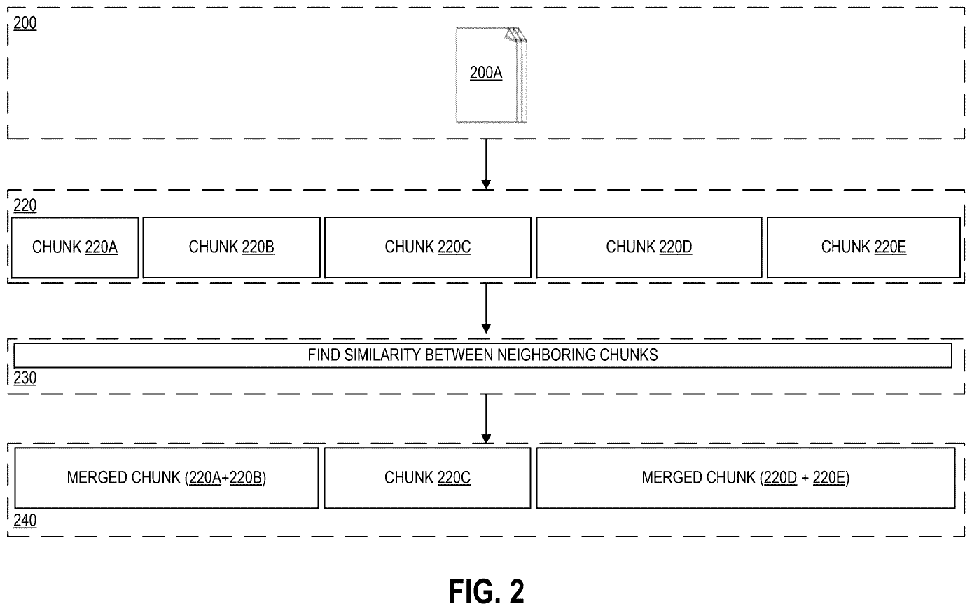

FIG. 2 illustrates an adaptive chunking process, in accordance with some examples described herein. In this example, a computer system is configured to generate adaptive chunks as described throughout the disclosure. The computer system configured to execute the adaptive chunking process may be similar to other computer systems described in the disclosure (e.g., RAG system 102 in FIG. 1).

At block 200, a document 200A is received by the system. The document may comprise information that may be analyzed and used in generating a response to a user query/prompt. The document 200A may be prepared and utilized later for quick, contextual data retrieval in generating the response.

At block 220, the document 200A is analyzed to generate initial chunks of data (chunks 220A-220E). For example, each initial chunk may be separated by a newline character/delimiter to create a set of chunks. The system may encode each of the initial chunks into a vector embedding or other numerical representation of the document. The chunk sizes may be fixed by a defined number, that defined number being indicative of a word window or word boundaries specified by a user or calculated by the computer system. As described above, chunking in accordance with examples of the disclosed technology is performed in an adaptive manner, where attempts to chunk a document are performed in a hierarchical and iterative manner. That is, a first attempt is made to chunk document 200A using paragraphs as chunk delineators. A determination as to whether or not a chunk is “permitted” can be made, the determination being whether or not the chunks (initially created on the basis of paragraphs) comport with the defined word window/preferred word count or word boundaries. If so, the chunk can stand/is permitted. If not, a second attempt is made to chunk document 200A (or particular paragraphs, that when chunked in the first attempt do not comport with the defined word window or word boundaries), this time using sentences as the chunk delineator. If valid chunks are created, the adaptive chunking process can end, but if not, a third attempt can be made to chunk document 200A (or particular paragraphs/sentences, that when chunked in the second attempt do not comport with the defined word window/boundaries) using words as delineators.

Accordingly, and as described herein, due to the adaptive chunking, the size of the initial chunks can vary. For example, boundary limits of (80, 118) permits chunks to be generated that are anywhere from 80 words to 118 words. In some scenarios, the last chunk to be generated from a document can experience slightly expanded variance. That is, and as will be described in greater detail below, a last generated chunk may exceed/fall below an upper or lower word boundary, respectively. It should be noted that figures of the present disclosure are not necessarily drawn to scale.

In some examples, the initial chunks may be stored in a temporary cache location or computer memory. For example, the vector embedding corresponding to the initial chunks may be stored in a temporary cache location or computer memory.

At block 230, a similarity process is executed to determine similarity metrics between neighboring chunks of data (e.g., the initial chunks). The similarity metric may define the similarity between two chunks (similarity referring to contextual similarity) when the chunks are compared with each other. The similarity calculation may be computed using a cosine similarity. The similarity metric may be within a range from 0 to 1, where 1 means identical vectors and 0 means orthogonal (completely dissimilar), recalling that chunks are vectorized to create vector embeddings. The similarity between chunks is calculated from the vector embeddings that represent the chunks.

In some examples, the similarity between the initial chunks can be compared to a similarity threshold. When the similarity threshold is met/exceeded, the system may determine that the initial chunks are similar. For example, following the above example, where 1 means identical vectors, and 0 means orthogonal vectors, a similarity threshold may be set to 0.85. When the similarity between chunks is calculated, chunk pairs with a similarity metric of at least 0.85 can be merged (to preserve/enhance context).

At block 240, the chunks determined to be merge-able based on similarity are merged. In some examples, the merged chunks may include multiple paragraphs, or sentences, or portions of a sentence(s). In this example, a first merged chunk comprises chunks 220A and 220B, and a second merged chunk comprises chunks 220D and 220E. In this example, chunk 220C is not merged with another chunk, e.g., chunk 220C was not similar enough to any neighboring chunks to warrant a merger.

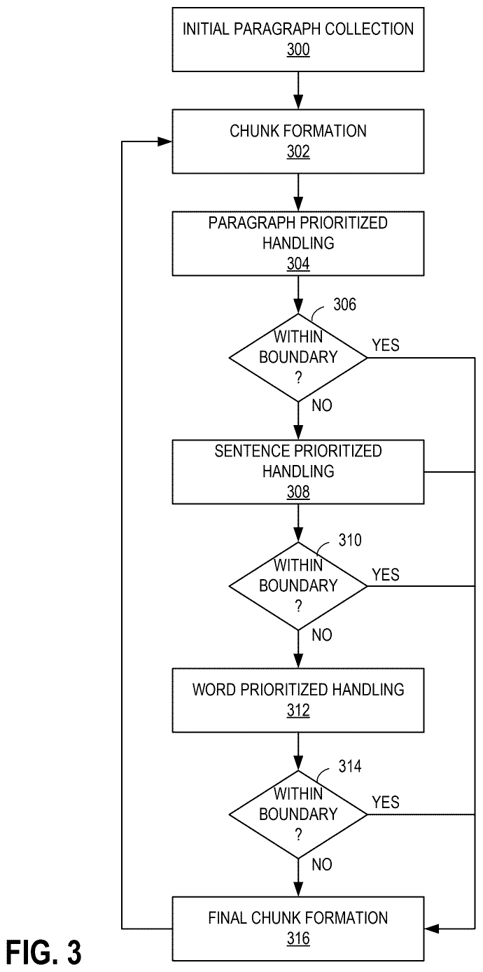

FIG. 3 illustrates operations that may be performed in accordance with examples of the disclosed technology to effectuate adaptive chunking. As described herein, examples of the disclosed technology can perform adaptive chunking by attempting to initially chunk a document/information source into one or more paragraphs that comport with a specified word limit or word boundaries.

At operation 300, initial paragraph collection may be performed. That is, the entirety of or portion(s) of interest within the document/text can be traversed to determine the existence of paragraphs in the document. Traversing the document can comprise looking for certain delineators (e.g., certain characters, lines without text, etc.) to determine the existence of paragraphs in the document. For example, text that exists between or is framed by certain delineators suggests that the text comprises a paragraph. The collected paragraphs may be stored or cached in an array, and each of the collected paragraphs can be treated as an individual “unit” for consideration (to be adaptively chunked).

At operation 302, chunks are formed. Chunk formation can refer to the creation of a data structure, i.e., a chunk, that contains the text of a paragraph, for example, that is being processed. This chunk data structure can then be used to check for compliance with word boundary limits, and for further processing, as may be the case. That is, each paragraph can be checked to determine if its word count (the number of words in a paragraph) falls within the word boundary limits (e.g., upper boundary and lower boundary). Using the aforementioned sliding window or in accordance with a specified or determined boundary limits, the word count of a collected paragraph can be checked to determine if it falls within the boundary limits.

At operation 304, paragraph-prioritized handling of chunks is performed. Thus, considering a first paragraph chunk, as described above at operation 302, a check can be performed to determine if the current chunk (the first paragraph chunk) is within the specified boundary limits at operation 306. If so, the chunk is a valid size (its word count comports with the boundary limits), and the current chunk can be finalized at operation 316. Processing can return to the chunk formation operation 302 where a subsequent paragraph (along with any remaining text, if present, based on whether the current paragraph was broken up into sentences or words) is used to create a subsequent paragraph chunk data structure. The word count of the subsequent paragraph chunk is checked, and the process described herein may be repeated.

If the paragraph is not within the boundary limits, sentence prioritized handling at operation 308 can be performed. For example, if the paragraph making up the current chunk exceeds the upper boundary, the paragraph is broken up into sentences. That is, the paragraph is parsed or traversed to determine the existence of, e.g., sentence delineators, and based on those sentence delineators, the paragraph is broken up into sentences/sentences within the paragraph chunk are identified. Once broken up into sentences, a check can be performed at operation 310 to determine whether or not a combination of successive sentences (less than the entire paragraph) can form a chunk that comports with the boundary limits. If some combination of sentences comports with the boundary limits, the current chunk can be finalized/finally formed using the combinable sentences at operation 316. For example, to effectuate a time-efficient manner of adaptive chunking, attempts can be made to add sentences to a current chunk until, e.g., the upper boundary, is met. That is, as a document is parsed, paragraphs are identified and stored in an array (memory only), and the paragraphs are sequentially traversed in the array, one by one, and chunks can be created as warranted. It should be noted that because the creation of a subsequent chunk does not occur until processing of a current paragraph is complete, whatever remains (whether multiple sentences only a part of a sentence, along with any remaining sentences of the current paragraph) can be used to create the next chunk. This ensures that chunks are created sequentially, and any remaining text from the current paragraph is carried over to form the next chunk.

If the paragraph exceeds a boundary limit, and there is no combination of whole sentences that can be combined to form a valid chunk, i.e., a chunk whose word count is within the boundary limits, the sentences can be broken down into words and processed in accordance with word prioritized handling at operation 312. That is, if after breaking the current paragraph into sentences and the current paragraph and sentences are analyzed, a determination is made at operation 310 that the current chunk exceeds the upper boundary, one or more words from the last sentence that causes the current chunk to exceed the upper boundary can be excluded to create a compliant chunk. That is, after breaking up the sentence into words, at operation 314, a check can be performed to determine if some, but not all, of the words of the sentence can remain with the paragraph/sentences of the current chunk and remain compliant with the upper boundary. This chunk can be finalized at operation 316.

If the current chunk comprises a paragraph that is smaller than the lower boundary, the word size of the next paragraph in the array can be checked to determine if this next paragraph can be combined with the paragraph making up the current chunk, and still remain within the boundary limits at operation 306. If so, the next paragraph in the array can be combined with the current chunk's paragraph, and the combination chunk can be finalized at operation 316. It should be noted that depending on the sizes of subsequent paragraphs, more than two paragraphs may be combined to form a chunk so long as the word count remains within the boundary limits.

However, if the next paragraph cannot be combined with the current chunk's paragraph (in this case, the next paragraph would be too large to combine in full with the current chunk's paragraph), again, the process proceeds with sentence prioritized handling at operation 308. As described above, the current chunk's paragraph can be broken up by sentences. Once broken up into sentences, a check can be performed at operation 310 to determine whether or not a combination of successive sentences (less than the entire paragraph) can form a chunk that comports with the boundary limits. If some combination of sentences comports with the boundary limits, the current chunk can be finalized/finally formed using the combinable sentences at operation 316.

If after breaking the current paragraph into sentences and the current paragraph and sentences are analyzed, a determination is made at operation 310 that the current chunk exceeds the upper boundary, one or more words from the last sentence that causes the current chunk to exceed the upper boundary can be excluded to create a compliant chunk. That is, after breaking up the sentence into words, at operation 314, a check can be performed to determine if some of the words can be appended to the paragraph/sentences of the current chunk and remain compliant with the upper boundary. This chunk can be finalized at operation 316.

It should be noted that any leftover portion of a paragraph or sentence that does not fit into a current chunk will be used to start a new chunk.

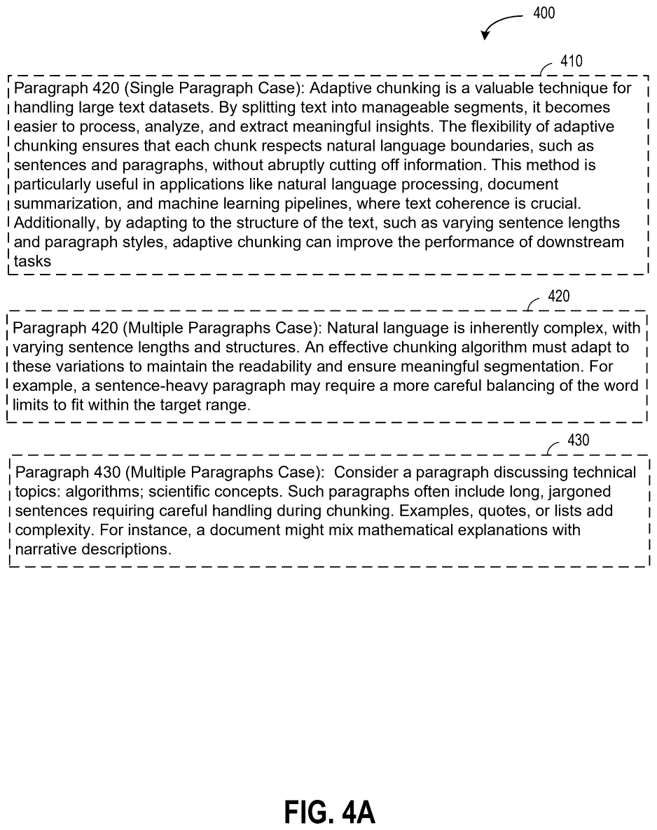

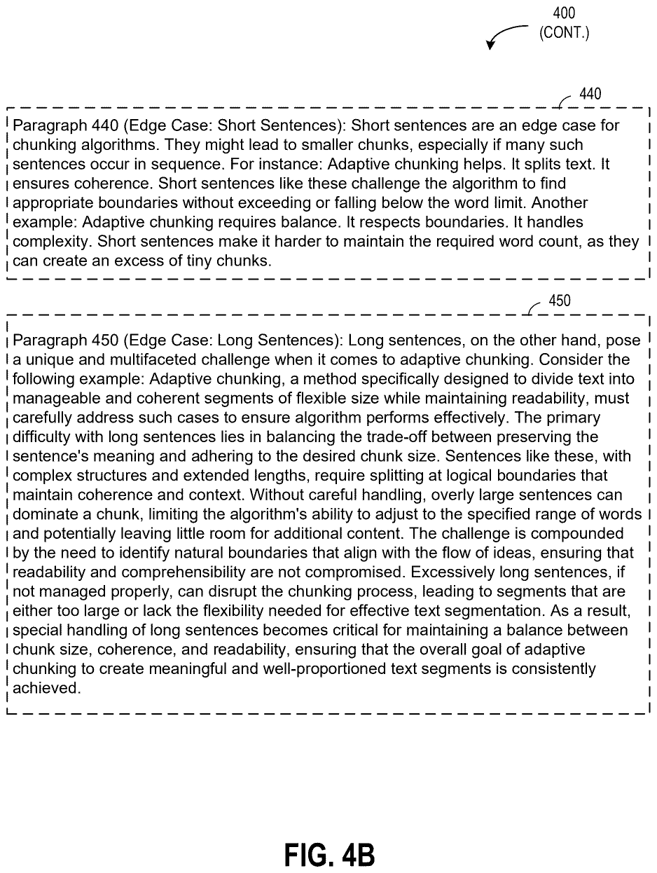

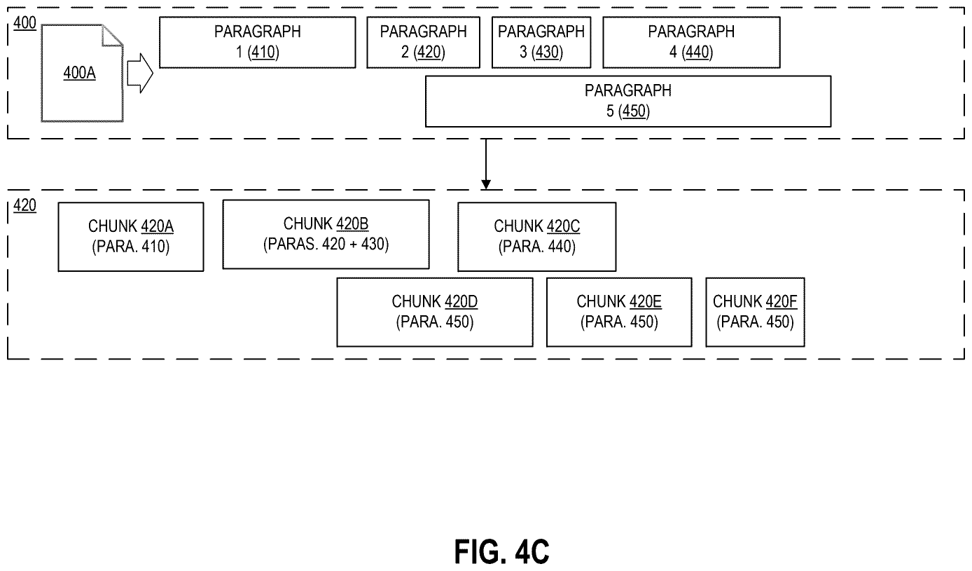

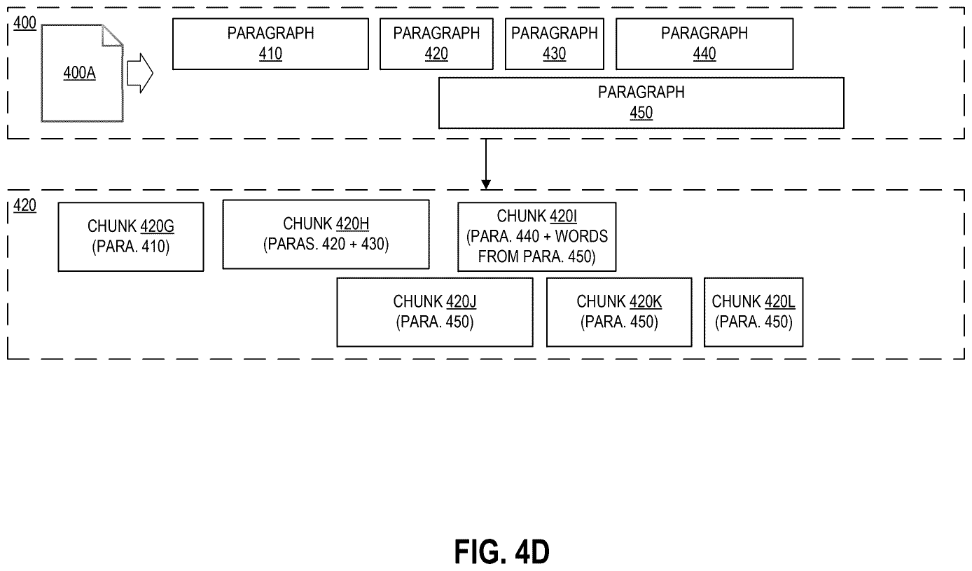

FIGS. 4A and 4B illustrate portions of a document 400, in this example, a plurality of paragraphs 410, 420, 430, 440, and 450. In this example, paragraph 410 is paragraph comprising a plurality of sentences having a total of 103 words. Paragraph 420 is a paragraph comprising multiple sentences having a total of 54 words. Paragraph 430 is a paragraph comprising multiple sentences having a total of 43 words. Paragraph 440 is made up of a plurality of sentences, and total of 91 words, while paragraph 450 is made up of a plurality of sentences totaling 223 words.

By adaptive chunking, examples of the disclosed technology would produce the following chunks based on specified word boundary limits of (80, 118). That is, a chunk should be no less than 80 words and no more than 118 words. As will be described in greater detail below, a user may opt to strictly adhere to the boundary limits or a user may opt to allow for a little leeway in the boundary limits. In some scenarios, the last chunk may not necessarily comply with the boundary limits because no more paragraphs/sentences/words are left in the document/source file with which to perform adaptive chunking.

Referring now to FIG. 4C, and similar to the example illustrated in FIG. 2, at block 400 a document 400A is initially chunked into five paragraphs, paragraph 410, paragraph 420, paragraph 430, paragraph 440, and paragraph 450. As described above, paragraphs will initially be prioritized when chunking document 400A. Paragraph 410, being 103 words, is on its own, able to satisfy the boundary limits. Accordingly, a chunk comprising paragraph 410 can be finalized as a chunk 420A. Paragraph 420, however, being only 54 words, falls short of the lower boundary of 80 words, and as described above, with paragraph prioritized handling, an attempt will be made to combine the current chunk's paragraph, paragraph 420, with a next paragraph, in this example, paragraph 430. When combined, the chunk, chunk 420B, becomes 97 words (54 words from paragraph 420 and 43 words from paragraph 430). A chunk size of 97 words comports with the boundary limits, and thus, can stand as a valid chunk. Paragraph 440, at 91 words can be finalized as a chunk 420C because 91 words resides within the boundary limits (80,118).

However, paragraph 450 is 223 words long, and thus, as a single paragraph, violates the boundary limits. As noted above, boundary limits can be strictly adhered to, or some leeway can be given. An example portion of code that can be used to specify the boundary limits for adaptive chunking in accordance with an example of the disclosed technology is as follows:
for i, chunk in enumerate(chunk_by_paragraphs(text.split(‘\n’), True, (80, 118)), 1): print(f“Chunk {i}: Size:{len(chunk.split( ))}\n{chunk}\n”)

By specifying that the boundary limits must be “True,” the boundary limits are strictly followed. Thus, paragraph 450 can first be broken up into sentences, and through adaptive chunking, a first chunk 420D of 100 words can be formed. Chunk 420D may end with the sentence stating “Sentences like these, with complex structures . . . that maintain coherence and context.” This is because the next full sentence, “Without careful handling, overlay large sentences . . . leaving little room for additional content,” is 30 words. Thus, including that next full sentence would cause chunk 420D to exceed the upper boundary. In this example, because a boundary limit-compliant portion of a paragraph can be chunked, i.e., the first 100 words of paragraph 450, there is no need to progress to word-based chunking. The remaining portion of the paragraph beginning with the sentence, “Without careful handling, overly large sentences . . . ” is 123 words, and thus violates the specified upper boundary. Going by sentences, adaptive chunking results in the creation of chunk 420E. Chunk 420E comprises the sentences, “Without careful handling, overly large sentences . . . either too large or lack the flexibility needed for effective text segmentation,” resulting in a chunk with 85 words. The next (and last) sentence of paragraph 5, “As a result, special handling . . . text segments is consistently achieved,” is 38 words, and thus, as a whole sentence, could not have been combined with the preceding sentences that make up chunk 420E or the resulting chunk would have been too large and would have exceeded the upper boundary. But, because chunk 420E fell within the boundary limits, there was no need to further break down the sentences of paragraph 450 into words. As noted above, the last chunk may not necessarily comport with the specified boundary limits. Here, the last sentence of paragraph 5, as noted above, is 38 words, and this last sentence/portion of paragraph 450 can be used to form and finalize chunk 420F.

If, on the other hand, a choice is made that strict adherence to the boundary limits is not needed, the above-mentioned code can be modified as follows:
for i, chunk in enumerate(chunk_by_paragraphs(text.split(‘\n’), False, (80, 118)), 1): print(f“Chunk {i}: Size:{len(chunk.split( ))}\n{chunk}\n”)

By indicating that the boundary limits of (80, 118) can be false, adaptive chunking in accordance with examples of the disclosed technology can result in the formation of chunks with different word sizes than the example of FIG. 4C. That is, instead of creating chunks 420D, 420E, and 420F, that are 100, 85, and 38 words long, respectively, the words making up chunks 420E and 420F can instead be combined into a single chunk that is 123 words (not shown). This is because strict adherence to the boundary limits is not required.

FIG. 4D illustrates another example, where the boundary limits are (95, 105), and like the example of FIG. 4C, paragraph 410, which is 103 words, falls within the boundary limit of (95, 105). Thus, a chunk comprising paragraph 410 can be formed and finalized as chunk 420G. A chunk 420H comprising paragraphs 420 and 430 with a word count of 97 can be formed and finalized.

Unlike the example of FIG. 4C, paragraph 440, which is 91 words, falls short of the lower boundary. According to adaptive chunking, if paragraph prioritized handling cannot achieve or create a chunk that comports with the specified boundary limits, sentence prioritized handling is attempted. In this case, the next sentence is the first sentence of paragraph 450, “Paragraph 450 (Edge Case: Long Sentences): Long sentences, on the other hand, pose a unique and multifaceted challenge when it comes to adaptive chunking.” Keeping this sentence whole, and attempting to append this to paragraph 440 would exceed the upper boundary. Thus, word prioritized handling is performed, where the sentences of paragraph 450 are broken up into words. To meet the lower boundary limit, the first four words of the first sentence of paragraph 450, i.e. “Paragraph 450 (Edge Case:” can be appended to the end of paragraph 440 to create a chunk that is 95 words. The remainder of paragraph 450 can be chunked into chunks 420J, 420K, and 420L. Chunk 420J, based on sentence priority handling, comprises the words, “Long Sentences): Long sentences, on the other hand . . . require splitting at logical boundaries that maintain coherence and context” and is 96 words long. Chunk 420K comprises the words, “Without careful handling, . . . long sentences becomes critical,” and meets that lower boundary of 95 words. Chunk 420L comprises the words “for maintaining a balance between . . . is consistently achieved” and is 28 words. Again, the last chunk may not necessarily comport with the boundary limits.

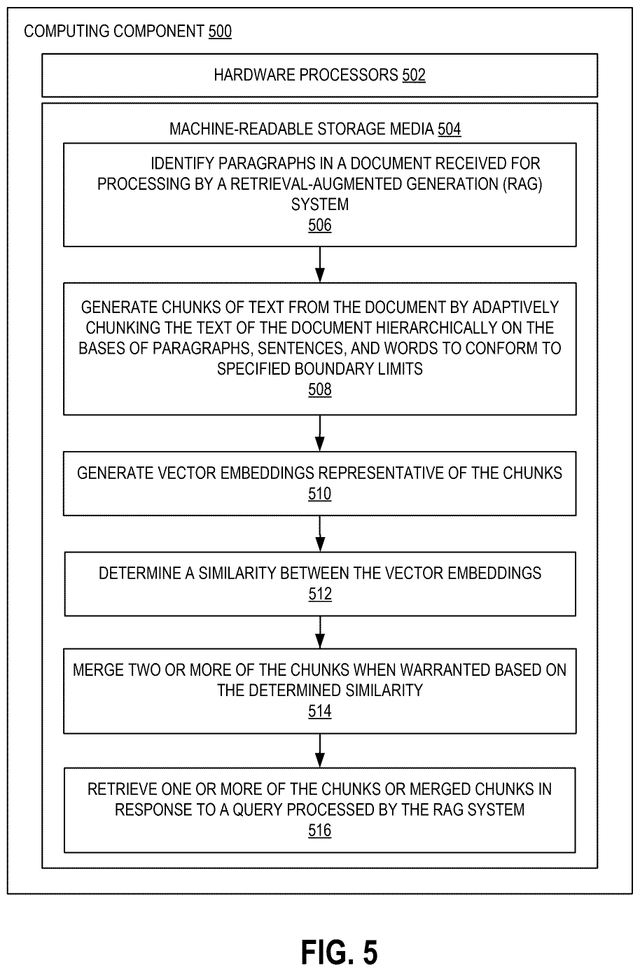

FIG. 5 illustrates a computing component that may be used to implement adaptive chunking, in accordance with various examples of the disclosed technology. In this example, computing component 500 may be, for example, a server computer, a controller, or any other similar computing component capable of processing data. In the example implementation of FIG. 5, the computing component 500 includes hardware processor 502 and machine-readable storage medium 504.

Hardware processor 502 may be one or more central processing units (CPUs), graphics processing units (GPUs), semiconductor-based microprocessors, and/or other hardware devices suitable for retrieval and execution of instructions stored in machine-readable storage medium 504. Hardware processor 502 may fetch, decode, and execute instructions, such as instructions 506-516, to control processes or operations for adaptive chunking. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-516.

Hardware processor 502 may execute instruction 506 to identify paragraphs in a document received for processing by a RAG system. The document may comprise logical sections, like sub-sections of the document (e.g., an “Abstract” section or table definition). The content of the document may comprise an author's organization of the content that is coherent and organized in paragraph form. The document may also comprise tables, charts, images, or other components in addition to sentence/paragraph formatting. As described above, RAG systems may be used to retrieve information from, e.g., an external knowledge base to enhance the output of LLMs with information that results in a more contextually relevant or accurate response. As described above, the document may initially be broken up into paragraphs pursuant to identifying paragraphs in the document based on delineators such as newline characters, periods or other punctuation (sets of punctuation), etc.

Hardware processor 502 may execute instruction 508 to generate chunks of text from the document by adaptively chunking the text of the document hierarchically on the bases of paragraphs, sentences, and words to conform to a specified boundary limit. That is, the RAG system implementing adaptive chunking attempts to create chunks based on entire paragraphs. If a current chunk (initially, a paragraph-based chunk) comports with specified boundary limits, e.g., upper and lower boundaries, the current chunk is valid/can be finalized. If the current chunk does not meet the specified boundary limits, the current chunk and remaining (non-finalized) chunks can be broken up on the basis of sentences. If one or more sentences (from a subsequent one of the remaining chunks) can be added to the current chunk, or one or more sentences of the current chunk can be removed such that the boundary limits are met, the current chunk can be formed/finalized. If not, the current chunk and the remaining chunks can be broken up on a word-by-word basis, and one or more words can be added to or removed from the current chunk such that the current chunk is made to comport with the specified boundary limits. In this way, a document can be chunked, adaptively, on the basis of different units of words (paragraphs, sentences, individual words themselves).

As noted above, in some examples, specified boundary limits can be calculated rather than specified by a user. Calculating boundary limits can be performed using standard deviation and median lengths of paragraphs, or using a multiplier. For example, as discussed above, pursuant to hardware processor 502 executing instruction 506 to identify paragraphs of the document, the RAG system can calculate the median length of the paragraphs of the document. This can provide a robust measure of a central tendency of the document's paragraphs in terms of length. The standard deviation of the paragraphs' lengths may also be calculated to obtain a representation of the variability in paragraph length. Based on the calculated median and standard deviation, initial boundary limits can be set, where the minimum/lower boundary is reflected as the calculated median minus the standard deviation, and where the maximum/upper boundary is reflected as the calculated median plus the standard deviation.

It should be noted that high variance in boundary limits can lead to excessively wide boundaries which can result in the formation of chunks that are either too small or too large. Additionally, skewed data may prevent boundaries from reflecting a typical length of paragraph in the document. In such cases, examples of the disclosed technology may defer to user-specified boundary limits or chunk sizes according to which adaptive chunking is performed. It should be noted that skewed data in this context can refer to data that is not symmetrically distributed and does not conform to a normal (bell curve) distribution. In the context of PDFs, this can occur when paragraphs have highly varying lengths, resulting in a distribution that is not balanced. This means that the data points (paragraph lengths) are unevenly spread out, with some paragraphs being very short and others being very long, rather than clustering around a central value. An example of skewed data can be a Q/A-based document, where questions might be very short and answers can be very long, leading to a highly uneven distribution of paragraph lengths

Hardware processor 502 may execute instruction 510 to generate vector embeddings representative of the chunks. Vectorizing the chunks allows the chunks to be more efficiently/simply represented, i.e., numerically, while still retaining the semantic meaning and relationships within/between the chunks.

In accordance with examples of the disclosed technology, hardware processor 502 may execute instruction 512 to determine a similarity between the vector embeddings. That is, the vectorized embeddings representative of the chunks can be compared to determine chunks' similarity to one another. A similarity threshold can be defined, and similarity values between the vector embeddings can be determined and subsequently compared to the similarity threshold.

If the similarity between at least two chunks meets or exceeds the similarity threshold, those chunks may be deemed to be similar enough to one another such that hardware processor 502 may execute instruction 514 to merge two or more of the chunks, when warranted, based on the determined similarity. In some examples a limit to the number of chunks that can be merged may be specified. Merging the chunks based on similarity after already having undergone adaptive chunking can enhance the context of portions of the document that can aid in augmenting the response of an LLM.

Hardware processor 502 may execute instruction 516 to retrieve one or more of the chunks or merged chunks in response to a query processed by the RAG system. As discussed above, RAG systems are typically meant to provide additional, contextual information from a knowledge base (outside its training data) in order to optimize the output of an LLM. The adaptive merging, and when warranted, subsequent merging of chunks can help provide optimally-related or contextual RAG-based information.

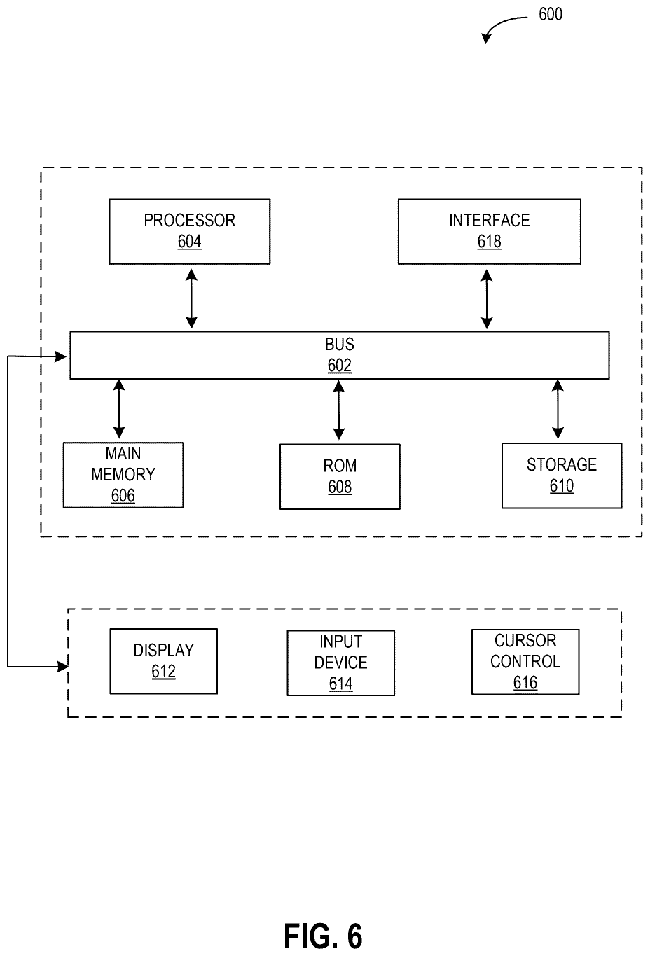

FIG. 6 depicts a block diagram of an example computer system 600 in which various examples of the disclosed technology described herein may be implemented. Computer system 600 includes bus 602 or other communication mechanism for communicating information, one or more hardware processors 604 coupled with bus 602 for processing information. Hardware processor(s) 604 may be, for example, one or more general purpose microprocessors, and may be used to embody a RAG system, such as RAG system 102, or one or more aspects/elements thereof.

Computer system 600 also includes main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes read only memory (ROM) 608 or other static storage device coupled to bus 602 for storing static information and instructions for processor 604. Storage device 610, such as a magnetic disk, optical disk, or USB thumb drive (Flash drive), etc., is provided and coupled to bus 602 for storing information and instructions.

Computer system 600 may be coupled via bus 602 to display 612, such as a liquid crystal display (LCD) (or touch screen), for displaying information to a computer user. The information may include, for example, a response to the user prompt/query that was submitted to the computer system implementing the RAG process and adaptive chunking. Input device 614 (e.g., keyboard or touch screen) may be used to provide the user prompt/query to the computer system and cursor control 616 (e.g., mouse or touchpad) may be used to select various portions of the screen while providing the user prompt/query.

Computer system 600 may include a user interface module to implement a GUI to provide to display 612. The user interface module may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 600 may implement the techniques described herein using customized hard-wired logic, one or more ASICs or FPGAs, firmware and/or program logic which in combination with the computer system causes or programs computer system 600 to be a special-purpose machine. According to one example of the disclosed technology, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

Computer system 600 also includes interface 618 coupled to bus 602. Interface 618 provides a two-way data communication coupling to one or more network links that are connected to one or more local networks. For example, interface 618 may be an integrated services digital network (ISDN) card, cable modem, satellite modem, or a modem to provide a data communication connection to a corresponding type of telephone line. As another example, interface 618 may be a local area network (LAN) card to provide a data communication connection to a compatible LAN (or WAN component to communicate with a WAN). Wireless links may also be implemented. In any such implementation, interface 618 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

1. A computer-implemented method comprising:
identifying paragraphs in a document received for processing by a retrieval-augmented generation (RAG) system by parsing the document to identify delineators that frame subsets of text of the document;
generating chunks of text from the document by adaptively chunking the text of the document hierarchically on the bases of paragraphs, sentences, and words to conform to specified boundary limits by creating data structures containing the subsets of the text of the document making up the paragraphs, and determining word counts of the chunks of text to check for conformity of the paragraphs to the specified boundary limits, the specified boundary limits comprising at least an upper word limit;
breaking up a current chunk of text of the chunks of text into sentences in response to determining that the word count of the current chunk of text fails to conform to the upper word count limit;
generating vector embeddings representative of the chunks;
determining a similarity between the vector embeddings;
merging two or more of the chunks when warranted based on the determined similarity; and
retrieving one or more of the chunks or merged chunks in response to a query processed by the RAG system.

2. (canceled)

3. The computer-implemented method of claim 2, further comprising storing the paragraphs, once identified, into a memory array.

4. (canceled)

5. The computer-implemented method of claim 4, wherein the specified boundary limits further comprises at least one of a lower word count limit, and a preferred word count.

6. The computer-implemented method of claim 5, further comprising finalizing the current chunk of text of the generated chunks of text in response to determining that a word count of the paragraph represented by the current chunk of text conforms to the upper word count limit.

7. (canceled)

8. The computer-implemented method of claim 1, further comprising determining whether a combination of successive sentences whose word count is less than that of the paragraph conforms to the upper word count limit.

9. The computer-implemented method of claim 8, further comprising finalizing the current chunk of text comprising the combination of successive sentences in response to determining that the word count of the combination of successive sentences represented by the current chunk of text conforms to the upper word count limit.

10. The computer-implemented method of claim 9, further comprising appending remaining sentences of the paragraph initially represented by the current chunk to a subsequent chunk of text.

11. The computer-implemented method of claim 7, further comprising breaking up the current chunk of text into words in response to determining that the word count of the current chunk of text fails to conform to the upper word count limit.

12. The computer-implemented method of claim 11, further comprising excluding one or more words of a last sentence from the current chunk of text such that the current chunk of text conforms to the upper word count limit, and finalizing the current chunk of text.

13. The computer-implemented method of claim 12, further comprising appending remaining words of the last sentence to a subsequent chunk of text.

14. The computer-implemented method of claim 5, further comprising determining that a word count of a paragraph represented by a current chunk of text is less than the lower boundary limit.

15. The computer-implemented method of claim 14, further comprising determining whether a word count of a subsequent chunk of text comprising a subsequent paragraph whose word count, that when combined with the word count of the paragraph represented by the current chunk of text falls between the upper and lower boundary limits.

16. The computer-implemented method of claim 15, further comprising finalizing a combined chunk of text comprising the current paragraph and the subsequent paragraph in response to determining that the combined word counts falls between the upper and lower boundary limits.

17. A system, comprising:
a processor; and
a memory comprising computer code, that when executed in real-time during generation of a large language model (LLM) response to a query, causes the processor to:
identify paragraphs making up a document;
form a current chunk of text comprising an individual paragraph of the identified paragraphs making up the document;
perform paragraph-prioritized handling to determine whether the current chunk of text conforms to one or more specified boundary limits, and finalizing the current chunk of text in response to a determination that the current chunk of text conforms to the one or more specified boundary limits;
perform sentence-prioritized handling to determine whether the current chunk of text conforms to the one or more specified boundary limits in response to a determination that the current chunk of text fails to conform to the one or more specified boundary limits pursuant to the paragraph-prioritized handling, and finalizing the current chunk of text in response to a determination that the current chunk of text conforms to the one or more specified boundary limits;
perform word-prioritized handling to determine whether the current chunk of text conforms to the one or more specified boundary limits in response to a determination that the current chunk of text fails to conform to the one or more specified boundary limits pursuant to the sentence-prioritized handling, and finalizing the current chunk of text in response to a determination that the current chunk of text conforms to the one or more specified boundary limits,
wherein the one or more specified boundary limits comprise an upper word count limit;
break up the current chunk of text into sentences in response to determining that the word count of the current chunk of text fails to conform to the upper word count limit; and
retrieve the current of text in response to the query.

18. The system of claim 17, wherein the specified boundary limits further comprises at least one of a lower word count limit, and a preferred word count.

19. A system, comprising:
a first engine to:
identify paragraphs in a document, and generate at least one of paragraph-prioritized chunks, sentence-prioritized chunks, and word-prioritized chunks in a hierarchical manner from the document depending on whether or not one or more word boundary limits are met by the at least one of the paragraph-prioritized chunks, sentence-prioritized chunks, and word-prioritized chunks, wherein at least one of the one or more word boundary limits comprises an upper word count limit;
upon meeting the one or more word boundary limits with the at least one of the paragraph-prioritized chunks, sentence-prioritized chunks, and word-prioritized chunks, finalize the at least one of the paragraph-prioritized chunks, sentence-prioritized chunks, and word-prioritized chunks;
upon determining that the word count of a current chunk of text fails to conform to the upper word count limit, break up the current chunk of text comprising an individual paragraph of the at least one of the paragraph-prioritized chunks, sentence-prioritized chunks, and word-prioritized chunks into sentences;
a second engine to:
retrieve the at least one of the paragraph-prioritized chunks, sentence-prioritized chunks, and word-prioritized chunks in response to a query processed by a retrieval-augmented generation (RAG) system.

20. The system of claim 19, comprising a third engine to merge two or more of the at least one of the paragraph-prioritized chunks, sentence-prioritized chunks, and word-prioritized chunks upon determining that the two or more of the at least one of the paragraph-prioritized chunks, sentence-prioritized chunks, and word-prioritized chunks are contextually similar.

21. The system of claim 19, further comprising breaking up the current chunk of text into words in response to determining that the word count of the current chunk of text fails to conform to the upper word count limit.

22. The system of claim 21, further comprising excluding one or more words of a last sentence from the current chunk of text such that the current chunk of text conforms to the upper word count limit, and finalizing the current chunk of text.

23. The system of claim 22, further comprising appending remaining words of the last sentence to a subsequent chunk of text.
